(19) United States
(12) Patent Application Publication
(10) Pub. No.: US 2012/0075260 A1
(43) Pub. Date: Mar. 29, 2012

(54) ACTIVE-MATRIX ORGANIC EL DISPLAY DEVICE AND METHOD FOR DRIVING SAME

(75) Inventors: Nobuyoshi SAITO, Kanagawa-ken (JP); Yujiro Hara, Kanagawa-ken (JP); Tomomasa Ueda, Kanagawa-ken (JP); Shintaro Nakano, Kanagawa-ken (JP); Kentaro Miura, Kanagawa-ken (JP)

(73) Assignee: Kabushiki Kaisha Toshiba, Tokyo (JP)

(21) Appl. No.: 13/051,201

(22) Filed: Mar. 18, 2011

(30) Foreign Application Priority Data
Sep. 27, 2010 (JP) 2010-215695

(51) Int. Cl. G09G 5/00

(52) U.S. Cl. 345/204

(57) ABSTRACT

According to one embodiment, an active-matrix organic EL display device includes a display region and a peripheral region. The display region includes a plurality of pixels disposed in a matrix configuration. The peripheral region includes a drive circuit. The pixel includes a bottom gate-type first transistor, a cathode electrode, an anode electrode, and an organic EL layer provided between the cathode electrode and the anode electrode. The drive circuit includes a bottom gate-type second transistor and a back gate electrode provided on the second transistor. A gate potential of the first transistor is lower than a potential of the cathode electrode when the pixel displays a minimum luminance.

### CROSS-REFERENCE TO RELATED APPLICATIONS

This application is based upon and claims the benefit of priority from the prior Japanese Patent Application No. 2010-215695, filed on Sep. 27, 2010; the entire contents of which are incorporated herein by reference.

### FIELD

Embodiments described herein relate generally to an active-matrix organic EL display device and a method for driving the same.

### BACKGROUND

In recent years, organic electroluminescence (EL) display devices, which are self-luminescent organic EL elements, are drawing attention and are being researched successfully as planar display devices. Compared to a liquid crystal display device that uses a liquid crystal cell including a pixel circuit to control the transmitted light intensity from a backlight, an organic EL display device uses a self-luminescent organic EL element. Therefore, the organic EL display device has features such as no backlight required a wide viewing angle, and fast response which is desirable for motion pictures.

Similarly to a liquid crystal display device, an organic EL display device may utilize a simple (passive) matrix and an active matrix as the driving method. In an active matrix, the current flowing in the organic EL element is controlled by an active element, e.g., a thin film transistor (TFT) and the like, provided inside the same pixel circuit as the organic EL element. An active-matrix display device can be large with high display precision.

In an active-matrix organic EL display device, transistors are provided both in the display region and in the peripheral drive circuit provided peripherally to the display region for driving. Each of the pixels of the display region normally includes two types of transistors, i.e., a program transistor configured to program a voltage corresponding to an image signal to the pixel and a drive transistor (a first transistor) configured to provide a current corresponding to the programmed signal voltage to the organic EL element.

The transistors of the display region and the peripheral driver circuit generally have been utilized by being controlled to have an enhancement mode characteristic. This is because it is desirable for the OFF current I_{off} to be low to perform logic operations in the peripheral drive circuit. However, the characteristic of such a transistor unfortunately degrades because of stress due to constantly being positive. In particular, the driving transistor for an organic EL is required to be highly stable because the drive transistor is used to control gray scale of luminance.

### BRIEF DESCRIPTION OF THE DRAWINGS

FIG. 1 is a block diagram of an organic EL display device according to a first embodiment;

FIG. 2 is an enlarged view illustrating a partial cross section of the organic EL display device according to the first embodiment;

FIG. 3 illustrates the relationship between a gate voltage and a drain current of a second transistor according to the first embodiment;

FIG. 4 illustrates the relationship between a gate voltage and a drain current of a first transistor according to the first embodiment;

FIG. 5 illustrates the relationship between the stress time (on the horizontal axis with units of seconds) and the threshold voltage Vₜₕ (on the vertical axis with units of V) of a transistor; and

FIG. 6 illustrates the relationship between the voltage of a cathode electrode and characteristics of a transistor including the cathode electrode in the upper portion.

### DETAILED DESCRIPTION

In general, according to one embodiment, an active-matrix organic EL display device includes a display region and a peripheral region. The display region includes a plurality of pixels disposed in a matrix configuration. The peripheral region includes a drive circuit. The pixel includes a bottom gate-type first transistor, a cathode, an anode, and an organic EL layer provided between the cathode electrode and the anode electrode. The drive circuit includes a bottom gate-type second transistor and a back gate electrode provided on the second transistor. A gate voltage of the first transistor is lower than a potential of the cathode electrode when the pixel displays a minimum luminance.

### First Embodiment

An active-matrix organic EL display device according to a first embodiment will now be described.

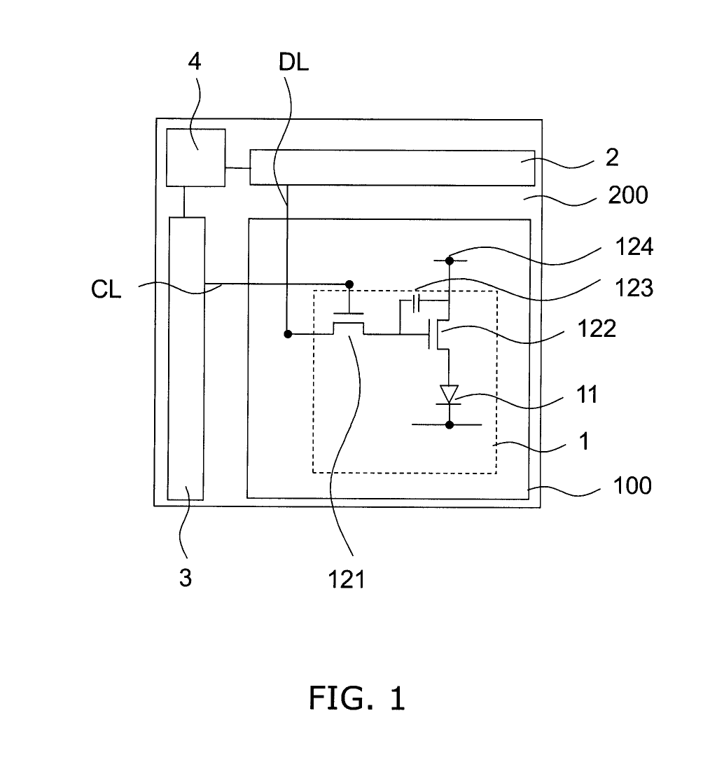

FIG. 1 is a plan view of the active-matrix organic EL display device. Although the organic EL display device includes multiple pixels disposed in a matrix configuration in a display region, one pixel is enlarged in the illustration of FIG. 1. The organic EL display device includes a display region 100 configured to display an image and a peripheral region 200 which is a region other than the display region.

A pixel 1 is provided in the display region 100. A signal line drive circuit 2, a control line drive circuit 3, and a controller 4 are provided in the peripheral region 200. The controller 4 is connected to the signal line drive circuit 2 and the control line drive circuit 3. The controller 4 is configured to perform a timing control of the operations of the signal line drive circuit 2 and the control line drive circuit 3.

The signal line drive circuit 2 and the pixels 1 are connected by multiple signal lines DL provided along a column direction in the drawings. The control line drive circuit 3 and the pixels 1 are connected by multiple control lines CL provided along a row direction in the drawings. The signal line drive circuit 2 supplies a signal voltage corresponding to an image signal through the signal line DL to the pixel 1. The control line drive circuit 3 supplies a scanning line drive signal through the control line CL to the pixel 1.

The pixel 1 includes an organic EL element 11 that emits light according to the supplied current, a program transistor 121, a drive transistor (a first transistor) 122, and a capacitor 123. The program transistor 121 and the drive transistor 122 are back gate-type thin film transistors. In other words, the gate electrode is provided on the substrate side of (in a layer under) the source electrode and the drain electrode. The signal line DL is connected to the source electrode of the program transistor 121; and the control line CL is connected to the gate electrode of the program transistor 121. The drain electrode of the program transistor 121 is connected to the gate electrode of the drive transistor 122.

The source electrode of the drive transistor 122 is connected to the anode electrode of the organic EL element 11. A power source line 124 is connected to the drain electrode of the drive transistor 122; and a positive power source voltage Vdd is supplied to the drain electrode of the drive transistor 122. The capacitor 123 is connected between the drain electrode of the program transistor 121 and the drain electrode of the drive transistor 122. The voltage of the cathode electrode of the organic EL element 11 is Vss. The program transistor 121 and the drive transistor 122 have the same configuration. The organic EL element includes an organic EL layer, the anode electrode, and the cathode electrode.

The transistor (a second transistor) is provided also in the signal line drive circuit 2 and the control line drive circuit 3 of the peripheral region 200. The second transistor also is a back gate-type thin film transistor. The second transistor of the peripheral region 200 has an enhancement mode characteristic. In other words, a current flows when the voltages of the source electrode and the gate electrode are the same. On the other hand, transistors 12 (the program transistor 121 and the drive transistor 122) of the display region 100 have a depletion mode characteristic. In other words, a current does not flow when the voltages of the source electrode and the gate electrode are the same.

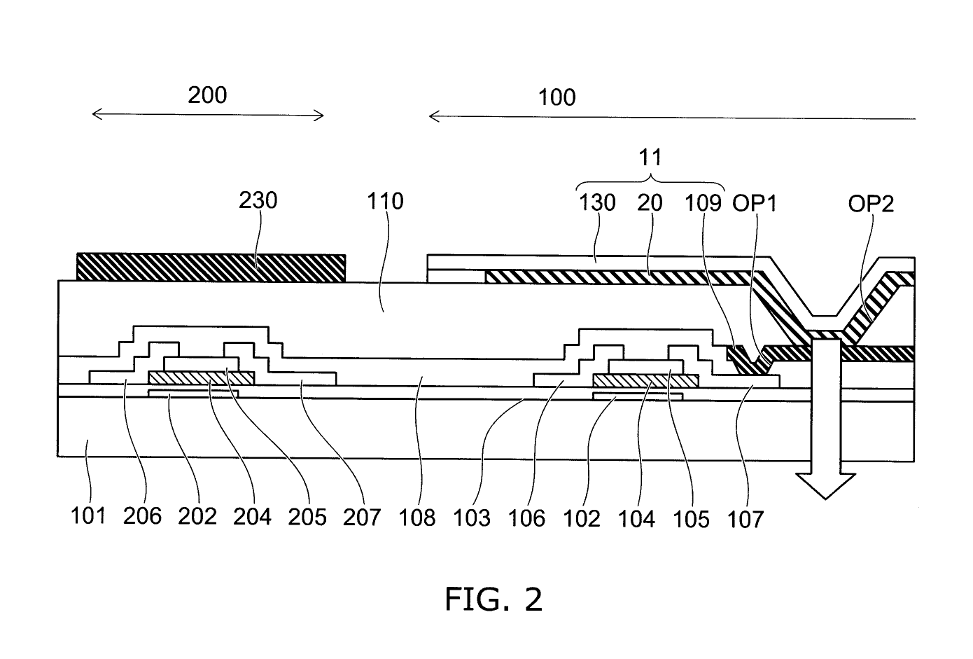

The first transistor 122 provided in the display region 100 and a second transistor 212 provided in the peripheral region 200 will now be described using FIG. 2. FIG. 2 is an enlarged view illustrating a partial cross section of the organic EL display device.

The first transistor 122 includes a substrate 101, a gate electrode 102 disposed on a portion of the substrate 101, a gate insulating film 103 covering the gate electrode 102, a semiconductor layer 104 disposed on a portion of the gate insulating film 103, a channel protection layer 105 provided on the semiconductor layer 104, and a source electrode 106 and a drain electrode 107 which are provided to overlap a portion of the channel protection layer 105 and the semiconductor layer 104 and disposed opposing each other on two sides of the semiconductor layer 104. The other portions of the source electrode 106 and the drain electrode 107 are provided on the gate insulating film 103.

Similarly, the second transistor 212 includes the substrate 101, a gate electrode 202 disposed on a portion of the substrate 101, the gate insulating film 103 covering the gate electrode 202, a semiconductor layer 204 disposed on a portion of the gate insulating film 103, a channel protection layer 205 provided on the semiconductor layer 204, and a source electrode 206 and a drain electrode 207 which are provided to overlap a portion of the channel protection layer 205 and the semiconductor layer 204 and disposed opposing each other on two sides of the semiconductor layer 204. The other portions of the source electrode 206 and the drain electrode 207 are provided on the gate insulating film.

A TFT protective film 108 covers the first transistor 122 and the second transistor 212. An opening OP1 is provided in the TFT protective film 108 on the gate electrode 102 of the first transistor 122. Anode electrodes are provided on the TFT protective film 108 to correspond one-to-one to the first thin film transistors 12. A portion of an anode electrode 109 covers the opening OP1 of the TFT protective film 108; and the anode electrode 109 contacts the drain electrode 107 of the first thin film transistor 12 through the opening OP1.

A passivation film 110 is provided on the TFT protective film 108 and the anode electrode 109. An opening OP2 is provided in the passivation film 110 on the anode electrode 109. The opening OP2 is provided in the passivation film 110; and an organic EL layer 20 is provided on the passivation film 110 to cover the first transistor 122. The organic EL layer 20 contacts the anode electrode 109 through the opening OP2. A first cathode electrode 130 is provided on the organic EL layer 20. A second cathode electrode 230 (the back gate electrode) is disposed on the passivation film 110 to correspond to the position where the second transistor 212 is provided.

The portion where the anode electrode 109, the organic EL layer 20, and the first cathode electrode 130 are stacked on the opening OP2 can emit light as illustrated by the arrow in FIG. 2.

The substrate 101 may include a material having an insulative surface such as, for example, a transparent glass substrate or a plastic film. However, this is not limited thereto. For example, an insulating layer may be provided on a non-transparent substrate such as, for example, silicon or stainless steel.

The gate electrodes 102 and 202 include an electrically conductive material. As the electrically conductive material, a refractory metal such as, for example, MoW (molybdenum tungsten), Ta (tantalum), and W (tungsten) may be used; an Al alloy having a main component of Al (aluminum) for which hillock-preventing measures are performed may be used; and Al may be stacked with the refractory metal.

The gate insulating film 103 may include an insulative material such as, for example, silicon oxide (SiOₓ). Other than silicon oxide, silicon nitride (SiNₓ), silicon oxynitride, etc., may be used; and a stacked film of these films may be used.

The semiconductor layers 104 and 204 may include, for example, an In—Ga—Zn—O-based amorphous oxide semiconductor formed using reactive sputtering. In the embodiment, the semiconductor layers are formed of an amorphous oxide semiconductor. The semiconductor layers 104 and 204 may have other compositions; and a polycrystalline semiconductor may be used. P-types, n-types, CMOS, etc., may be used. For an amorphous oxide semiconductor layer, a diffraction pattern and the like is not observed even when using, for example, transmission electron microscopy or X-ray diffraction.

In the case where an amorphous oxide semiconductor is used as the semiconductor layers 104 and 204, the film thickness thereof may be about 10 nm to 100 nm. Considering the electrical characteristics, it is favorable for the film thicknesses of the semiconductor layers 104 and 204 to be about 10 nm.

The channel protection layers 105 and 205 include an insulative material. In the case where an amorphous oxide semiconductor is used as the semiconductor layers 104 and 204, silicon oxide, which has an acid resistance higher than that of the semiconductor layers 104 and 204, may be used. Also, silicon nitride, silicon oxynitride, etc., may be used as the channel protection layers 105 and 205.

The source electrodes 106 and 206 and the drain electrodes 107 and 207 may include various electrically conductive materials such as, for example, a Ti/Al/Ti stacked film, a Mo/Al/Mo stacked film, etc.

The TFT protective film 108 may include, for example, an oxide film (SiOₓ), a nitride film (SiNₓ, where x is any positive value), an oxynitride film (SiON), and aluminum oxide (Al₂O₃).

The anode electrode 109 may include indium tin oxide (ITO), a stacked structure of ITO/Ag/ITO, AZO which is ZnO (zinc oxide) doped with Al, etc.

The passivation film 110 may include a photosensitive acrylic resin (PC401 manufactured by JSR), a photosensitive polyimide (DL1000 manufactured by Toray), etc.

The organic EL layer 20 may include a material that emits light when a voltage is applied.

The first cathode electrode 130 and the second cathode electrode 230 may include Al and/or MgAg.

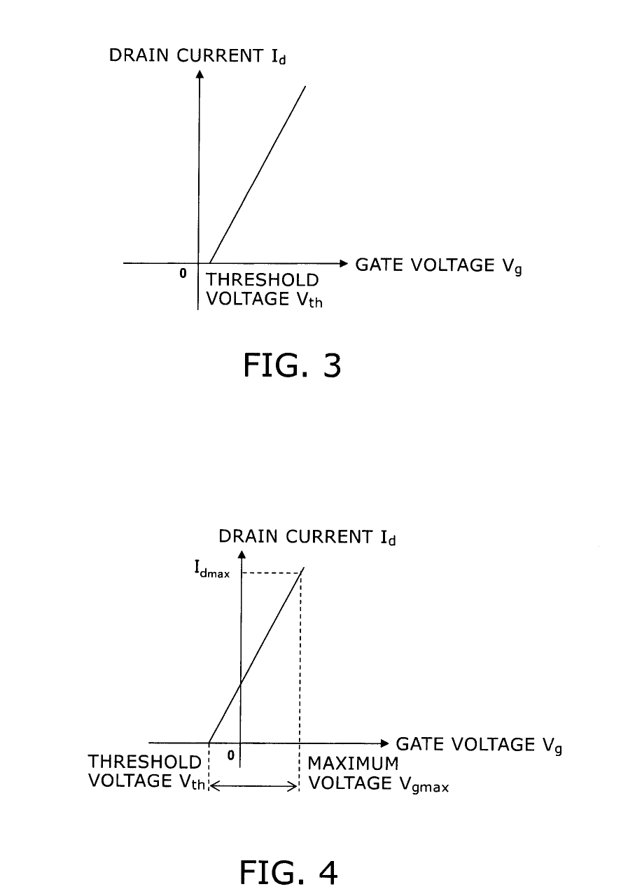

FIG. 3 illustrates the relationship between a gate voltage V_{g} (the horizontal axis) and a drain current I_{d} (the vertical axis) of the second transistor 212 having the enhancement mode characteristic. FIG. 4 illustrates the relationship between the gate voltage V_{g} (the horizontal axis) and the drain current I_{d} (the vertical axis) of the first transistor 122 having the depletion mode characteristic. Although the drain current I_{d} does not flow when the gate voltage V_{g} is less than the threshold voltage Vₜₕ, the drain current I_{d} flows proportionally to the size of the gate voltage V_{g} when the gate voltage V_{g} is greater than the threshold voltage Vₜₕ. A transistor in which the threshold voltage Vₜₕ is a positive value is called an enhancement mode transistor. On the other hand, a transistor in which the threshold voltage Vₜₕ is a negative value is called a depletion mode transistor.

Because the first transistor 122 is a depletion mode transistor, a voltage may be supplied between Vₜₕ and an arbitrary applied maximum voltage V_{gmax} as illustrated by the arrows in FIG. 4. In other words, both a positive voltage and a negative voltage may be applied to the first transistor 122. The gate potential of the first transistor is lower than the potential of the cathode electrode when the pixel displays the minimum luminance (black).

There is a risk that the threshold voltage Vₜₕ may shift from the initial value with the stress time (the total drive time) of the transistor.

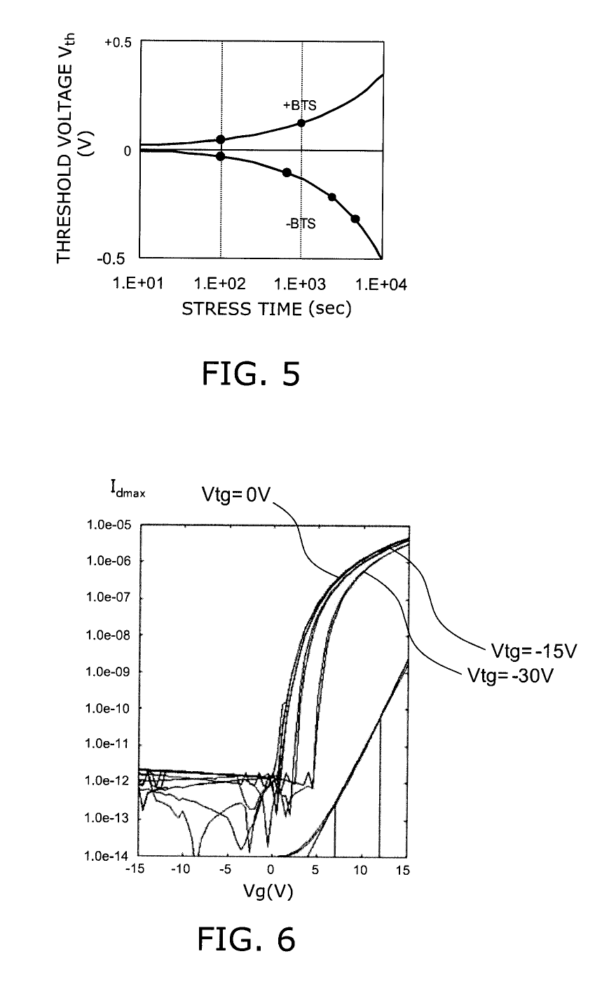

FIG. 5 illustrates the relationship between the stress time (on the horizontal axis with units of seconds) and the threshold voltage Vₜₕ (on the vertical axis with units of V) in the cases where the voltages V_{g} of +15 V and −15 V are supplied to the gate electrode for a transistor using an In—Ga—Zn—O-based semiconductor layer in a thermal environment of 80 degrees. In the case where the voltage V_{g} of +15 V is supplied to the gate electrode, the shift of the threshold voltage Vₜₕ increases with the stress time. In the case where the voltage V_{g} of −15 V is supplied to the gate electrode, the shift of the threshold voltage Vₜₕ decreases with the stress time.

Thus, in the case where a positive voltage is supplied constantly to the gate electrode 102, there is a risk that the value of the threshold voltage Vₜₕ may increase with the stress time to become higher than the design value. Because the threshold voltage Vₜₕ changes with the stress time, that is, because the degradation of the transistor is dependent on the stress time, there are cases due to the stress time where a current no longer flows even when, for example, the voltage V_{g} of +15 V is supplied to the gate electrode.

However, both a positive and negative voltage can be supplied to a depletion mode transistor. For the first transistor 122 included in the pixel 1 of the display region 100, the signal voltage for which the gate voltage V_{g} corresponds to the minimum luminance (black) is lower than the potential of the first cathode electrode. Because the gate voltage V_{g} can be negative during the low luminance display and positive during the high luminance (white) display, an effect is obtained in which the voltage stress of the high-luminance side and the voltage stress of the low luminance side cancel. Further, the voltage stress of the first transistor 122 due to the driving can be reduced because the voltage swing itself can be reduced. It is favorable for the threshold voltage Vₜₕ of the first transistor 122 to be in the range of −5 to 0 V. Accordingly, the threshold voltage Vₜₕ can be prevented from easily shifting with the stress time because the stress is mitigated more than in the case where a positive voltage is supplied constantly.

On the other hand, because the second transistor 212 is provided to drive the pixel 1 and to perform logic operations, it is desirable for the OFF current I_{off} to be small. In other words, it is desirable for the second transistor 212 to be an enhancement mode transistor.

Because the second cathode electrode 230 is provided independently from the first cathode electrode 130 in the embodiment, different voltages may be applied thereto. In the case where the potential of the second cathode electrode 230 is lower than a reference potential (a negative power source potential V_{off}) of the control line drive circuit 3 or the signal line drive circuit 2 in which the second transistor 212 is provided, the voltage applied to the gate electrode of the second transistor 212 can be shifted toward the positive side.

FIG. 6 illustrates the relationship between the gate voltage V_{g} (the horizontal axis) and the drain current I_{d} (the vertical axis) of a depletion mode transistor including a cathode electrode in the upper portion. The voltage applied to the cathode electrode is varied to be 0 V, −15 V, and −30 V. The gate voltage V_{g} is shifted toward the positive side as the cathode voltage decreases.

For the second transistor 212 included in the peripheral region 200, it is confirmed that the threshold voltage Vₜₕ can be controlled and operated on the positive side (the enhancement mode) by applying a potential lower than the Low level (the reference potential) of the circuit of the peripheral region 200 to the second cathode electrode 230.

In the organic EL display device, the first transistor 122 provided in the display region functions as a constant current source. The characteristic change of the transistor is visually confirmed by a person as being an analog luminance of the organic EL display device. In the case where the first transistor degrades, the luminance of the organic EL display device decreases a degree recognizable by the person. Accordingly, it is necessary to suppress the degradation over time of the characteristic (the threshold voltage Vₜₕ shift) due to the driving to an extremely small degree. By the first transistor 122 being a depletion mode transistor, the degradation of the first transistor can be prevented; and the reliability can be increased.

The second transistor 212 can be an enhancement mode transistor while having the same configuration as the first transistor 122 by using the second cathode electrode 230. Accordingly, the first transistor 122 and the second transistor 212 can be formed simultaneously. Also, the second cathode electrode 230 can be formed simultaneously with the first cathode electrode 130 with the same material; or the second cathode electrode 230 can be formed simultaneously with the anode electrode 109 with the same material. Accordingly, both the transistor of the display region and the transistor of the peripheral region of the organic EL display device of the embodiment can be manufactured with the same number of processes as that of an enhancement mode organic EL display device.

Although the second cathode electrode 230 includes MgAg in the description recited above, a stacked structure of ITO/Al/ITO may be used. In such a case, not only can the reliability of the TFT element be increased because the second transistor 212 can be optically shielded, but also the formation of only the back gate electrode can be performed using photolithography with higher patterning precision. Therefore, the occurrence of unnecessary parasitic capacitance in the peripheral circuit unit can be suppressed. To avoid an increase of the number of processes, the lower electrode or the upper electrode of the organic EL can be utilized as the second cathode electrode for controlling the threshold voltage Vₜₕ of the second transistor 212 of the peripheral region 200.

A specific method for constructing the organic EL display device will now be described.

First, Al and Ti of 200 nm and 30 nm are formed as a film used to form the scanning line and the gate electrode, respectively, by sputtering on a glass substrate and are patterned into a prescribed pattern. The patterning is performed using photolithography; and the etching utilizes RIE (reactive ion etching) using chlorine. Subsequently, 200 nm of SiO₂ is deposited as a gate insulating film using PE-CVD (plasma enhanced CVD of TEOS. Then, 30 nm of an In—Ga—Zn—O oxide is formed as a film on the gate insulating film using reactive DC sputtering. At this time, the proportion of the oxygen to the argon is 5%; and the metal compositional proportions of the oxide target are 40%, 40%, and 20%, respectively. The In—Ga—Zn—O oxide is etched using dilute hydrochloric acid; and 200 nm of SiO₂ is deposited as an etching stopper layer using PE-CVD of TEOS. Somewhat later, the etching stopper layer is patterned into a prescribed pattern. At this time, the etching is performed by RIE using CF₄. Here, a contact hole for the gate electrode draw out is made. Subsequently, 20 nm, 30 nm, 300 nm, and 30 nm of Ti, Al, and Ti are formed as a film used to form the source and drain electrodes by sputtering.

The source electrode and the drain electrode are patterned into a prescribed pattern by RIE using chlorine; and the configuration of the transistor is completed.

Subsequently, annealing is performed in a nitrogen atmosphere at 300° C. for about one hour to remove the element damage that occurred during the processes. The obtained transistor has a depletion mode characteristic. To further increase the reliability of the transistor, 100 nm of SiO₂ is deposited using PE-CVD; an acrylic photosensitive transparent resin is used to provide openings in prescribed locations; and these openings are used to make openings in the SiO₂ thereunder. The openings of the SiO₂ are made by RIE using CF₄.

Then, 10 nm, 100 nm, and 10 nm of ITO, Al, and ITO, respectively, are deposited as the lower electrode (the anode electrode) of the organic EL layer using sputtering; and these are etched into a prescribed pattern using a mixed acid of phosphoric acid, acetic acid, and nitric acid. Then, banks are formed using an acrylic photosensitive transparent resin.

A low molecular-weight organic EL layer is deposited thereon using vacuum vapor deposition. A metal mask is used to deposit a hole transport layer, a light emitting layer, and an electron transport layer for each RGB pixel; and then a MgAg alloy of about 30 nm is deposited as a semi-transmissive film as the upper electrode to complete the element. The MgAg film is formed not only in the display area but also on the transistors of the peripheral logic circuit to be used as the back gate electrodes.

Subsequently, a stacked film of SiN and an organic resin is used to seal the organic EL element to protect the organic EL element from the moisture and oxygen in the air; and the organic EL display device is completed.

The invention is not limited to the embodiments described above. For example, one skilled in the art may similarly practice the invention by appropriately selecting specific configurations of components included in transistors and active-matrix display devices from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all thin film transistors active-matrix display devices practicable by an appropriate design modification by one skilled in the art based on the thin film transistors and the active-matrix display devices described above as embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An active-matrix organic EL display device, comprising:
a display region including a plurality of pixels disposed in a matrix configuration; and
a peripheral region including a drive circuit,
the pixel including a bottom gate-type first transistor, a cathode electrode, an anode electrode, and an organic EL layer provided between the cathode electrode and the anode electrode,
the drive circuit including a bottom gate-type second transistor and a back gate electrode provided on the second transistor,
a gate potential of the first transistor being lower than a potential of the cathode electrode when the pixel displays a minimum luminance.

2. The device according to claim 1, wherein
the second transistor includes a semiconductor layer, and
the semiconductor layer includes an oxide semiconductor.

3. The device according to claim 2, wherein a voltage is supplied to the back gate electrode and a voltage is supplied to the cathode electrode.

4. The device according to claim 3, wherein the back gate electrode is formed of the same material as the cathode electrode.

5. The device according to claim 3, wherein the back gate electrode is formed of the same material as the anode electrode.

6. The device according to claim 1, wherein the gate potential of the first transistor is a negative value during a black display of the minimum luminance and a positive value during a white display.

7. The device according to claim 1, wherein a threshold of the gate potential of the first transistor has a negative value.

8. The device according to claim 7, wherein the threshold of the gate potential of the first transistor is in a range of −5 to 0 V.

9. The device according to claim 1, wherein a threshold of a gate potential of the second transistor has a positive value.

10. The device according to claim 1, wherein the back gate electrode is provided independently from the cathode electrode and has a potential different from the potential of the cathode electrode.

11. The device according to claim 1, wherein the first transistor and the second transistor have the same configuration.

12. The device according to claim 2, wherein the oxide semiconductor is amorphous.

13. The device according to claim 12, wherein the oxide semiconductor is based on In—Ga—Zn—O.

14. The device according to claim 13, wherein a film thickness of the semiconductor layer is 10 nm to 100 nm.

15. The device according to claim 3, wherein the back gate electrode is a stacked structure of ITO/Al/ITO, and the back gate electrode optically shields the second transistor.

16. The device according to claim 4, wherein the same material is ITO/Al/ITO.

17. The device according to claim 5, wherein the same material is ITO/Al/ITO.

18. The device according to claim 4, wherein the same material is MgAg.

19. The device according to claim 5, wherein the same material is MgAg.

20. A method for driving an active-matrix organic EL display device, the active-matrix organic EL display device including a display region including a plurality of pixels disposed in a matrix configuration; and a peripheral region including a drive circuit, the pixel including a bottom gate-type first transistor, a cathode electrode, an anode electrode, and an organic EL layer provided between the cathode electrode and the anode electrode, the drive circuit including a bottom gate-type second transistor and a back gate electrode provided on the second transistor, a gate potential of the first transistor being lower than a potential of the cathode electrode when the pixel displays a minimum luminance, the method comprising:
setting a potential of the back gate electrode to be lower than a reference potential of the drive circuit of the peripheral region.
